(19) United States
(12) Patent Application Publication
(10) Pub. No.: US 2008/0154431 A1
(43) Pub. Date: Jun. 26, 2008

(54) Initiation and Control of Nanothermal Plasmonic Engineering

(76) Inventors: Anthony Defries, Los Angeles, CA (US); Mark Brongersma, Redwood City, CA (US)

Correspondence Address: MATTER, INC., 1079 CARRARA PLACE, LOS ANGELES, CA, 90049, US

(21) Appl. No.: 11/781,889

(22) Filed: Jul. 23, 2007

Related U.S. Application Data
(60) Provisional application No. 60/821,312, filed on Aug. 3, 2006.
(60) Provisional application No. 60/821,316, filed on Aug. 3, 2006.

(51) Int. Cl. G01J 5/00; B01J 19/08

(52) U.S. Cl. 700/266; 250/526; 204/157.15; 977/902

(57) ABSTRACT

The present disclosure concerns a means to use at least a form of electromagnetic excitation or light-matter interaction, including solar or laser energy to generate localized conditions that enable initiation and spatial and temporal control of catalysis, chemical reactions, deposition, synthesis, photocatalysis, electrocatalysis and catalytic processes. Initiation and spatial and temporal control may be obtained by restricting and directing the electromagnetic excitation or light-matter interactions to specific objects or features embedded or located in or on a host matrix material or substrate. In some implementations this provides a means to use electromagnetic excitation to initiate and control chemical synthesis or reactions without entirely or partially heating any of or all of the reaction chamber, reactor mass, reaction precursors and products, or reactor substrate. It may further provide for the use of temperature sensitive elements or substrates. The method of use could include initiation and control of light-matter interactions addressed at optical and other frequencies to generate controlled localized thermal conditions. A further implementation concerns a means to employ electromagnetic excitation or light-matter interactions to generate localized thermal conditions to initiate or control or cause the combination, separation, reformation or reclamation of a gas, a combination of gasses, a material or a combination of materials in the form of a gas, plasma, solid or liquid. The method of use disclosed could provide a means to initiate and control chemical reactions for the generation, use, transfer and output of controlled localized thermal heat or energy. The method of use disclosed could provide a means to realize and control local thermal conditions down to or below the length scale of a single nanometer and down to or below the timescale of a single picosecond. In some implementations surface plasmon excitations may be used to realize and control local thermal conditions down to or below the length scale of a single nanometer and down to or below the timescale of a single picosecond.

### CROSS REFERENCE TO RELATED APPLICATIONS

This application claims benefit of and priority to U.S. Provisional Patent Application No. 60/821,312 filed Aug. 3, 2006 entitled “Use of Electromagnetic Excitation to Generate Localized Thermal Conditions for Control of Chemical Reactions and Catalytic Chemical Reactions” and U.S. Provisional Patent Application No. 60/821,316 filed Aug. 3, 2006 entitled “Use of Electromagnetic Excitation to Generate Controlled Localized Thermal Conditions for Initiation of Chemical Reactions”.

### STATEMENT AS TO RIGHTS TO INVENTIONS MADE UNDER FEDERALLY SPONSORED RESEARCH AND DEVELOPMENT

Not Applicable

### BACKGROUND

1. Field

The present disclosure concerns a means to use at least a form of electromagnetic excitation or light-matter interaction, including solar or laser energy to generate localized conditions that enable initiation and spatial and temporal control of catalysis, chemical reactions, deposition, synthesis, photocatalysis, electrocatalysis and catalytic processes. Initiation and spatial and temporal control may be obtained by restricting and directing the electromagnetic excitation or light-matter interactions to specific objects or features embedded or located in or on a host matrix material or substrate. In some implementations this provides a means to use electromagnetic excitation to initiate and control chemical synthesis or reactions without entirely or partially heating any of or all of the reaction chamber, reactor mass, reaction precursors and products, or reactor substrate. It may further provide for the use of temperature sensitive elements or substrates. The method of use could include initiation and control of light-matter interactions addressed at optical and other frequencies to generate controlled localized thermal conditions. A further implementation concerns a means to employ electromagnetic excitation or light-matter interactions to generate localized thermal conditions to initiate or control or cause the combination, separation, reformation or reclamation of a gas, a combination of gasses, a material or a combination of materials in the form of a gas, plasma, solid or liquid. The method of use disclosed could provide a means to initiate and control chemical reactions for the generation, use, transfer and output of controlled localized thermal heat or energy. The method of use disclosed could provide a means to realize and control local thermal conditions down to or below the length scale of a single nanometer and down to or below the timescale of a single picosecond. In some implementations surface plasmon excitations may be used to realize and control local thermal conditions down to or below the length scale of a single nanometer and down to or below the timescale of a single picosecond.

2. Related Art

Nanofabrication techniques have enabled the generation of features that can be addressed to manipulate light at the nanoscale. Nanoscale objects or apertures at the nanoscale allow electromagnetic energy to be addressed, concentrated or restricted to critical dimensions that are below the diffraction limit of the wavelength of irradiation used. These concentrated fields can be used by means of absorption to efficiently heat volumes of material down to or below the scale of a single nanometer. Due to the small heat capacity that volume of material would cool rapidly when the electromagnetic excitation or light-matter interactions is terminated. Depending on the thermal environment of the heated volume cooling could take place on a timescale down to or below a single picosecond. Such concentration could lead to massive field enhancements resulting in extreme control of light-matter interactions and local heating. An example of strong light-matter interactions can be found in metallic nanostructures. These interactions between electromagnetic excitations and metallic nanoparticles are studied in the field of plasmonics.

Plasmon excitations in metallic nanostructures can be exploited to dramatically improve spatial and temporal control over chemical reactions and deposition by nanothermal plasmonic engineering. The realization of controlled, nanoscale thermal environments has great fundamental and practical importance. Research in this area is driven by a desire to better control and monitor physicochemical or biochemical reactions and to develop thermally controlled nanoscale devices. In the field of plasmonics the unique optical properties of metallic nanostructures are harnessed to enable routing and manipulation of light at the nanoscale. This control over light-matter interactions is derived from the properties of nanostructured metals that support light-induced surface plasmon excitations or collective electron oscillations.

The surface plasmon resonance effect resulting from a strong interaction between light and nanostructured metals allows for development of a new generation of photonic devices and processing technologies. The surface plasmon resonance effect is identified and may be addressed by the absorption of electromagnetic energy at or near the surface plasmon resonance frequency. This phenomenon may be exploited to open new kinetic pathways for chemical synthesis and reactions that are thermodynamically unfavorable under current processing conditions. Reactions in which metallic nanoparticles provide the catalytic sites are excellent candidates for exploiting surface plasmon excitations. Synthesis routes or chemical reactions that benefit from local heating by surface plasmons are termed plasmon enhanced. Chemical reactions can also be plasmon enhanced through the ability to locally control temperatures and enable rapid heating and cooling. This allows for rapid switching between low and high temperature states of the catalyst particles. At low temperatures reactions proceed slowly, generating high molecular sticking probabilities. At high temperatures reactions proceed quickly and rapid desorption of reactants from the particles is ensured. Rapidly cycling the temperature of the particles would permit the thermodynamics of a reaction to be exploited at preferred processing temperatures.

Generating local heat through the use of plasmon excitations allows reactions to be stimulated in a low temperature environment. In some cases quantum effects associated with metal nanoparticles can be addressed to cause further unique behavior and increase reactivity of such particles. Nanothermal plasmonic engineering provides the ability to concentrate significant amounts of electromagnetic energy into nanoscale volumes and convert that electromagnetic energy into the excitation of electrons, phonons, polaritons, or lattice vibrations, i.e. heat. Local heat generation will give rise to a local temperature increase in proximity to the heated volume of material without heating the entirety of the reactor mass or surrounding environment. In some instances high temperatures may occur in a restricted area while heating a volume many times larger. The concomitant local temperature increase in the heated volume will facilitate new chemical and physical synthesis processes with improved performance by many orders of magnitude in both the degree of spatial and temporal control and energy efficiency.

Various aspects of surface plasmon excitations or plasmon-assisted reactions are being explored for the creation of new technologies including:

miniature optical sensors

investigations of the structure of molecules using surface enhanced Raman spectroscopy

monitoring of single biomolecules which have been labeled with nanoparticle “antennas”

optical microscopy with 20 nm spatial resolution

cancer chemotherapy through selective heating of malignant cells that have been targeted with nanoparticles

plasmon-based waveguides for microelectronics

plasmon-assisted heating for chemical vapor or thin film deposition, nanostructure growth and chemical catalysis

In the chemical industry metal nanostructures play a vital role as catalysts and are used in bulk quantities. It is well known that solid catalysts and systems employing solid catalysts can limit or restrict the speed and efficiency of chemical reactions. These issues require more precise control of catalyst heating and more precise placement of catalysts and chemicals. The invention described herein concerns the ability to address instantaneous delivery of localized focused heating to a desirable catalyst in a structure permitting precise placement to the desired chemical, reactant or product. Plasmon enhanced chemical reactions provide the means to determine and to change the exact location where a solid or structured catalyst is heated and by such heating to determine when and where reactions take place. The ability to focus heating in a specific area and rapidly change the delivery of that focused heating to adjacent areas permits the creation of high temperature regions surrounded by regions at lower temperatures. The large temperature gradient will result in rapid heat transport from the reaction site.

Highly exothermic reactions, e.g. Fischer-Tropsch (FT) and FT synthesis reactions may also be controlled by the use of plasmon enhanced chemical reactions in the manner described herein. Since excess heat in an FT reaction can lead to undesirable local temperature increase and catalyst overheating, a means to control removing or transferring some of the heat is desired. Major issues of exothermic reactions in general, and FT reactions in particular, include removing the heat of reaction and avoiding local overheating of the catalysts which can be resolved with the process described herein. Improved control of both exothermic and endothermic activity may be achieved through a more precise heating and cooling methodology described herein. The efficiency and yield of chemical reactions and processing may be significantly improved as the cycling time required for repeated heating and cooling of catalyst, reactant or product is reduced.

In an exemplary embodiment the invention described herein may be used for the initiation and control of catalysis, chemical reactions, photocatalysis, electrocatalysis, catalytic chemical reactions and chemical synthesis including FT and other exothermic or endothermic reactions. The method, process, features, means or structures of the invention described herein could be expressed in any combination in any or all of the following or any other architectures, form factors, materials or combination of materials including:

A metallic

A nonmetallic

An organic

An inorganic

A metal organic

A silicon

A silica

A silicate

A ceramic

A composite

A polymer

An organic composite thin film

An organic composite coating

An inorganic composite thin film

An inorganic composite coating

An organic and inorganic composite thin film

An organic and inorganic composite coating

A thin film crystal lattice nanostructure

An active photonic matrix

A flexible multi-dimensional film, screen or membrane

A microprocessor

A MEMS or NEMS device

A microfluidic or nanofluidic chip

A single nanowire, nanotube or nanofiber

A bundle of nanowires, nanotubes or nanofibers

A cluster, array or lattice of nanowires, nanotubes or nanofibers

A single optical fiber

A bundle of optical fibers

A cluster, array or lattice of optical fibers

A cluster, array or lattice of nanoparticles

Designed or shaped single nanoparticles at varying length scales

Nanomolecular structures

Nanowires, dots, rods, particles, tubes, sphere, films or like materials in any combination

Nanoparticles suspended in various liquids or solutions

Nanoparticles in powder form

Nanoparticles in the form of pellets, liquid, gas, plasma or otherwise

Nanostructures, nanoreactors, microstructures, microreactors, macrostructures or other devices

Combinations of nanoparticles or nanostructures in any of the forms described or any other form

Nanopatterned materials

Nanopatterned nanomaterials

Nanopatterned micro materials

Micropatterned metallic materials

Microstructured metallic materials

Metallic micro cavity structures

Metal dielectric materials

Metal dielectric metal materials

Combination of dielectric metal materials or metal dielectric metal materials

A paint, coating, powder or film in any form containing any of the materials identified herein or any other materials in any combination

All or any of the materials or forms described herein may be designed, used or deployed on or in flexible, elastic, conformable structures. Said structures or surface areas may be expanded or enlarged by the use of advanced non-planar, non-linear geometric and spatial configurations.

Further the method may incorporate metallic nanoparticle catalysts or nanostructures containing metallic nanoparticle catalysts to be included in the said structure or device. The use of light-matter interactions or electromagnetic excitation including solar energy or laser light to control and direct localized thermal conditions down to or below the length scale of a single nanometer and down to or below the timescale of a single picosecond in said catalysts or devices may allow for more precise chemical reactions to be initiated and controlled in those reactors, structures or devices. Rapid changes in the delivery and location of focused heating will reduce cycling times for repeated heating and cooling to improve the efficiency and yield of chemical reactions and processing. The following are examples of types of catalytic chemical reactions that could be initiated and controlled in this manner or otherwise by means of the invention described herein, e.g. synthesis of hydrocarbons from CO and H₂, steam reforming, acetylation, addition reactions, alkylation, dealkylation, hydrodealkylation, reductive alkylation, amination, aromatization, arylation, carbonylation, decarbonylation, reductive carbonylation, carboxylation, reductive carboxylation, reductive coupling, condensation, cracking, hydrocracking, cyclization, cyclooligomerization, dehalogenation, dimerization, epoxidation, esterification, exchange, halogenation, hydrohalogenation, homologation, hydration, dehydration, hydrogenation, dehydrogenation, hydrocarboxylation, hydroformylation, hydrogenolysis, hydrometallation, hydrosilation, hydrolysis, hydrotreating, hydrodesulferization/hydrodenitrogenation (HDS/HDN), isomerization, methanol synthesis, methylation, demethylation, metathesis, nitration, partial oxidation, polymerization, reduction, steam and carbon dioxide reforming, sulfonation, telomerization, transesterification, trimerization, water gas shift (WGS), and reverse water gas shift (RWGS).

Nanowires are typically grown in random arrays using a variety of chemical vapor deposition (CVD) techniques. The successful introduction of nanowires into electronic circuitry will require synthesis of nanowires in well-defined locations with controlled composition, diameter, and growth orientation. CVD is a key process for the fabrication of semiconductors, microelectronics, photonics and nanomaterials. There are a number of CVD methods in current use, e.g. Laser Assisted CVD (LACVD), Low Pressure CVD (LPCVD), Metal-Organic CVD (MOCVD), Plasma Enhanced CVD (PECVD) and Thermal Activation CVD (TACVD). In unique contrast to all existing methods of CVD the invention described herein includes a means to generate a thermal environment that can be controlled through the interaction of electromagnetic excitations with designed objects or apertures at length scales down to or below a single nanometer and timescales down to or below a single picosecond.

In an exemplary embodiment this invention may include initiation and control of electromagnetic energy in a structure or material, which contains an addressable plasmon resonant frequency, so as to influence one or more specific properties of said structure or material. It may also include combining conventional nanoparticle catalyzed CVD nanowire growth with surface plasmon induced local heating of the catalyst particle. Local heating of selected nanoscale regions can enable growth of nanowires in well-defined locations on a chip and thereby solve a number of issues associated with conventional CVD. Existing CVD methods for growing nanowires at positions defined by the precise placement of catalyst particles require relatively high temperatures. This makes conventional CVD unsuitable for positioning on many materials including plastics, glass and certain silicon surfaces used in standard semiconductor chip synthesis. Initiation and control of nanothermal plasmonic engineering for CVD could overcome this limitation and enable the creation of entirely new classes of devices, materials, and combinations of materials.

The importance of heat and metal catalysts in large-scale, continuous chemical processing cannot be overstated. Metals such as Al, Co, Ni, Ru, Rh, Ro, Pd, Os, Ir, Pt, Cu, Zi, Si, Mo and Fe serve as common catalysts. Typical reactions take place at hundreds or thousands of degrees Celsius. Controlled localized heating would support the function of scaling in a local reaction. Stimulating controlled localized thermal conditions could use such scaling to increase the efficiency of certain reactions. Minimal energy would be required to heat the reaction mass or chamber and greater temporal control over the reaction could be achieved. By cycling through different temperatures the process could take advantage of the strongly temperature dependent kinetics, thermodynamics and sticking coefficients of molecules.

An example is the widely used Fischer-Tropsch reaction: CO+H₂→CₙH₂ₙ₊₂, CₙH₂ₙ forms hydrocarbons from the catalysis of CO and H₂. The products of the reaction include methane, methanol, aldehydes, and ethanol depending on which catalyst is used. Al, Co, Ni, Ru, Rh, Ro, Pd, Os, Ir, Pt, Cu, Zi, Si, Mo and Fe are the most commonly used catalysts with iron being widely used in industrial processes such as coal gasification, gas liquefaction, fuel refining and reformation. The generation of controlled and rapidly changeable, localized thermal conditions could be used to obtain desired reaction kinetics, enhance yield and reduce total energy consumption.

The technology described herein may support low power, low cost, solar or other forms of photosynthesis or photocatalysis for controlled localized production of methane and hydrogen. In the near term existing hydrocarbon materials could be used. Ultimately decomposition or conversion of organic materials could serve as a clean renewable energy resource. This offers the potential for a prolonged and broadly based development of alternatives to hydrocarbon and fossil fuels.

The following are some examples of industries or applications in which the invention described herein might enable significant scaling improvements, energy savings, cost efficiencies or disruptive technologies:

Energy and Transportation

Semiconductors

Photonics

Electronics

Fuel Cells

Waste Treatment

Desalinization

Catalysis

Pharmaceuticals

Diamond Material Production

Composite Materials

Photolithography

Photovoltaics (solar cells)

Photocatalysis

Fertilizer & Food Production

Chemicals

Coal Gasification and Liquefaction

Methane and Hydrogen Production

Biotech

Carbon Reclamation

Cosmetics

Medical

Memory & Storage

Coating & Finishing

Plastics & Polymers

Gas to Liquid Conversion

Direct Methane Conversion

Microfluidics

Gas Synthesis

Water Treatment

Food Production

Light Emitting Diodes

Thermal Energy Conversion

Power Generation

### DESCRIPTION OF THE INVENTION

Metals can be thought of as a gas of conduction electrons. Similar to sound waves in a real gas, metals exhibit plasmon phenomena, i.e. electron density waves. Electron density waves can be excited at the interface between a metal and a dielectric. There is also a strong interaction of light with a metallic nanoparticle. At the surface plasmon resonance frequency, the electric field of a light wave induces a collective electron oscillation in the particle. Due to inelastic scattering processes, the kinetic energy of the electrons is rapidly converted to heat and the temperature of the nanoparticle is raised.

The time-varying electric field associated with light waves can exert a force on the gas of negatively charged electrons and drive them into a collective oscillation. There are interesting analogies of this phenomenon to driving a gas of molecules into a resonant collective oscillation by blowing on a flute. The motion of the oscillating electrons in the particles is strongly damped in collisions with other electrons and lattice vibrations (phonons) and the kinetic energy of the electrons is rapidly converted into heat on a 1-10 femtosecond timescale (one femtosecond=one quadrillionth of a second).

This process can be used for the rapid, controlled heating and cooling of particles to enable new methods for micro, nano manufacturing and molecular synthesis. It is important to note that very low energy input is required to obtain a significant temperature rise in nanoscale particles. This energy could be delivered in a spatially and temporally controlled fashion by solar energy, a lamp, a laser or a broadband solid-state light source. When the light source is interrupted the particle cools and the thermal energy gained rapidly dissipates into a larger, cooler thermal mass on which the particle is positioned (10 ps-1 ns). This process can be used for very fast switching between low and high temperature states of the particle.

This invention concerns the use of electromagnetic energy alone or combined with surface plasmon resonance frequency effects to generate controlled localized thermal conditions. As a function of this invention said thermal conditions could be used for the control of chemical reactions, deposition, synthesis, and catalytic chemical reactions without entirely or partially heating all or any of the reaction chamber, reactor mass, reactant, product, or reactor substrate. This invention concerns the use of said frequency effects to enable controlled, localized plasmon assisted reactions to obtain improved results in a low temperature environment. This invention provides the ability to concentrate significant amounts of electromagnetic energy into nanoscale volumes and convert that electromagnetic energy into the excitation of electrons, phonons, polaritons, or lattice vibrations, i.e. heat. Local heat generation will give rise to a local temperature increase in proximity to the heated volume of material without heating the entirety of the reactor mass or surrounding environment. In some instances high temperatures may occur in a restricted area while heating a volume many times larger. The concomitant local temperature increase in the heated volume will facilitate new chemical and physical synthesis processes with improved performance by many orders of magnitude in both the degree of spatial and temporal control and energy efficiency

An exemplary embodiment of the invention described herein may include the ability to extend the effects of local heating to adjacent particles, materials or structures. Electromagnetic excitation of specific objects or features may be used to drive reactions, e.g. growth of particles, materials or structures in proximity to the heated object or feature. An electromagnetic excitation induced in a metallic particle could generate a thermal environment in particles, materials or structures in proximity to the excited particle and cause subsequent catalysis or growth, e.g. on a silicon wafer. This embodiment may include cycling of temperatures in particles, materials or structures in proximity to the heated objects or features in the manner described by this invention.

In an alternative embodiment, this invention could provide for initiating and controlling localized heating effects to be induced in non-metallic, organic or inorganic materials as the continuation of a plasmon assisted deposition, reaction or similar process. The method may employ the use of plasmon resonant frequency effects on a metallic catalyst to initiate and control a reaction in an adjacent non-catalyzed, non-metallic material. Continued plasmon resonant frequency oscillation of the catalyst may cause prolonged heating of the selected adjacent material. This would provide for the use of selected electromagnetic excitation or light-matter interactions to generate controlled localized thermal conditions in organic or inorganic materials for a variety of purposes.

This invention further concerns the use of resonant light-matter interaction effects to attain controlled localized thermal conditions. In one implementation this invention could provide a means to deliver at least one form of electromagnetic energy to cause at least the combination, separation, reformation or reclamation of at least a gas, a combination of gasses, a material or a combination of materials in the form of a gas, plasma, solid or liquid. In an alternative implementation this invention could provide a means to initiate and control the generation, use, transfer and output of controlled localized thermal energy.

The method of use disclosed could provide a means to realize local thermal conditions at the nanoscale below the diffraction limit for the electromagnetic waves used. In some implementations surface plasmon excitations may be used to achieve desired thermal conditions at the nanoscale. Nanoscale objects or apertures at the nanoscale allow electromagnetic energy to be addressed, concentrated or restricted to critical dimensions that are below the diffraction limit of the wavelength of irradiation used. These concentrated fields can be used by means of absorption to efficiently heat volumes of material down to or below the scale of a single nanometer. Due to the small heat capacity that volume of material would cool rapidly when the electromagnetic excitation or light-matter interactions is terminated. Depending on the thermal environment of the heated volume cooling could take place on a timescale down to or below a single picosecond. The concentration could lead to massive field enhancements resulting in extreme control of light-matter interactions and local heating.

The method of use could further provide for surface plasmon resonance effects or light-matter interactions to take place in a thermally controlled environment, particle, material or structure. In some circumstances the method may include changing, reducing or controlling the temperature of said environment, particle, material or structure in order to achieve greater efficiency in realizing any of the effects obtained by the invention described herein.

In an exemplary embodiment of the invention described herein the selective excitation of electrons, molecules, particles, materials and structures may be controlled by means of a surface plasmon resonant frequency excited by the use of electromagnetic radiation or energy transfer.

In any exemplary embodiment or description contained herein the method of enabling the various functions, tasks or features contained in this invention includes performing the operation of some or all of the steps outlined in conjunction with the preferred processes or devices. This description of the operation and steps performed is not intended to be exhaustive or complete or to exclude the performance or operation of any additional steps or the performance or operation of any such steps or any of the steps in any different sequence or order.

The foregoing means and methods are described as exemplary embodiments of the invention. Those examples are intended to demonstrate that any of the aforementioned steps, processes or devices may be used alone or in conjunction with any other in the sequence described or in any other sequence.

What is claimed is:

1. A method to initiate or control at least one form of electromagnetic excitation or light matter interaction in the process of thermal energy generation including:
a means to initiate and control localized heating at or below the length scale of a single nanometer caused by electromagnetic excitation.
a means to initiate and control thermal energy caused by electromagnetic excitation.
a means to spatially and temporally initiate and control the increase or decrease in temperature of a material structure caused by electromagnetic excitation.
a means to initiate and control the local temperature of one or more of the materials or structures subjected to electromagnetic excitation.
a means to control thermal energy caused by electromagnetic excitation.
a means to control the increase or decrease in temperature caused by electromagnetic excitation.
a means to control the local temperature of one or more of the materials subjected to electromagnetic excitation.
a means to initiate and control local heating by changing any one or any number of the focus, wavelength, power density, polarization, or pulsing of the excitation beam causing the heating.
a means to initiate and control local heating by employing a resonant excitation beam in combination with conventional resistive heating technology.
a means to initiate and control local heating and cooling by control of the thermal properties of the surrounding host or the substrate.
a means to initiate and control the thermal environment of the host material or structure for resonant light-matter interactions.
a means to change the temperature of the host material or structure for resonant light-matter interactions.
a means to increase, reduce, maintain or control the temperature of the host material, structure or environment provided for the performance of resonant light-matter interactions.
a means to control the thermal environment adjacent or in proximity to an electromagnetically excited structure or material.
a means to change the temperature of the environment adjacent or in proximity to an electromagnetically excited structure or material.
a means to increase, reduce, maintain or control the temperature of the host material, structure or environment by exploiting electromagnetic excitations.
a means to use plasmon enhanced light-matter interactions in metallic particles to extend the effects of local heating to adjacent particles, materials or structures, whether metallic or non-metallic.
a means to use plasmon enhanced light-matter interactions in metallic particles to initiate and control local heating in adjacent particles, materials or structures, whether metallic or non-metallic.
a means to use plasmon enhanced light-matter interactions in metallic particles to extend the effects of local heating to adjacent particles, materials or structures, whether organic or inorganic.
a means to use plasmon enhanced light-matter interactions in metallic particles to initiate and control local heating in adjacent particles, materials or structures, whether organic or inorganic.
a means to control localized heating caused by electromagnetic excitation.

2. The method of claim 1 which includes a means to initiate and control localized heating at or below the length scale of a single nanometer caused by electromagnetic excitation including:
a means to initiate and control resonant light-matter interactions at or below the length scale of a single nanometer and at or below the timescale of a single femtosecond.

3. The method of claim 1 to at least initiate and at least control the excitation of at least one form of electromagnetic excitation or light-matter interaction in a structure, which incorporates at least one material which contains at least an addressable frequency in at least a flexible, conformable, addressable structure which may be expressed in at least a matrix, film, lattice, mesh, membrane, screen, mask, micro electrical mechanical systems device, nanoelectrical mechanical systems device, microchemical systems, microprocessor, semiconductor, crystalline lattice, microfluidics or nanofluidics channel, or a plurality, multiplicity, series or combination of any such forms or structures or any such or similar forms or structures including:
a means to excite at least one form of electromagnetic excitation or light-matter interactions in a structure, which incorporates at least one material which contains at least an addressable frequency in at least a flexible, conformable, addressable structure which may be expressed in at least a matrix, film, lattice, mesh, membrane, screen, mask, micro electrical mechanical systems device, nanoelectrical mechanical systems device, microchemical systems, microprocessor, semiconductor, crystalline lattice, microfluidics or nanofluidics channel, or a plurality, multiplicity, series or combination of any such forms or structures or any such or similar forms or structures which structures may contain at least nanowires, dots, rods, particles, tubes, sphere, films or like materials in any combination.
a means to excite at least one form of electromagnetic excitation or light-matter interactions in a structure, which incorporates at least one material which contains at least an addressable frequency in at least a planar one dimensional flexible, conformable, addressable structure which may be expressed in at least a matrix, film, lattice, mesh, membrane, screen, mask, micro electrical mechanical systems device, nanoelectrical mechanical systems device, microchemical systems, microprocessor, semiconductor, crystalline lattice, microfluidics or nanofluidics channel, or a plurality, multiplicity, series or combination of any such forms or structures or any such or similar forms or structures.
a means to excite at least one form of electromagnetic excitation or light-matter interactions in a structure, which incorporates at least one material which contains at least an addressable frequency in at least a two dimensional flexible, conformable, addressable structure which may be expressed in at least a matrix, film, lattice, mesh, membrane, screen, mask, micro electrical mechanical systems device, nanoelectrical mechanical systems device, microchemical systems, microprocessor, semiconductor, crystalline lattice, microfluidics or nanofluidics channel, or a plurality, multiplicity, series or combination of any such forms or structures or any such or similar forms or structures.
a means to excite at least one form of electromagnetic excitation or light-matter interactions in a structure, which incorporates at least one material which contains at least an addressable frequency in at least a multi-dimensional flexible, conformable, addressable structure which may be expressed in at least a matrix, film, lattice, mesh, membrane, screen, mask, micro electrical mechanical systems device, nanoelectrical mechanical systems device, microchemical systems, microprocessor, semiconductor, crystalline lattice, microfluidics or nanofluidics channel, or a plurality, multiplicity, series or combination of any such forms or structures or any such or similar forms or structures.
a means to excite at least one form of electromagnetic excitation or light-matter interactions in a structure, which incorporates at least one material which contains at least an addressable frequency which can at least be a variable frequency in at least a flexible, conformable, addressable structure which may be combined with at least one like structure expressed in at least a matrix, film, lattice, mesh, membrane, screen, mask, micro electrical mechanical systems device, nanoelectrical mechanical systems device, microchemical systems, microprocessor, semiconductor, crystalline lattice, microfluidics or nanofluidics channel, or a plurality, multiplicity, series or combination of any such forms or structures or any such or similar forms or structures.
a means to excite at least one form of electromagnetic excitation or light-matter interactions in a structure, which incorporates at least one material which contains at least an addressable frequency in at least a flexible, conformable, addressable structure which may be expressed as a template in at least a matrix, film, lattice, mesh, membrane, screen, mask, micro electrical mechanical systems device, nanoelectrical mechanical systems device, microchemical systems, microprocessor, semiconductor, crystalline lattice, microfluidics or nanofluidics channel, or a plurality, multiplicity, series or combination of any such forms or structures or any such or similar forms or structures.
a means to excite at least one form of electromagnetic excitation or light-matter interactions in a structure, which incorporates at least one material which contains at least an addressable frequency in at least a flexible, conformable, addressable structure at least portions of which may be instructed to output thermal energy expressed in at least a matrix, film, lattice, mesh, membrane, screen, mask, micro electrical mechanical systems device, nanoelectrical mechanical systems device, microchemical systems, microprocessor, semiconductor, crystalline lattice, microfluidics or nanofluidics channel, or a plurality, multiplicity, series or combination of any such forms or structures or any such or similar forms or structures.
a means to excite at least one form of electromagnetic excitation or light-matter interactions in a structure, which incorporates at least one material which contains at least an addressable frequency in at least a flexible, conformable, addressable structure at least portions of which may be instructed to respond to thermal energy expressed in at least a matrix, film, lattice, mesh, membrane, screen, mask, micro electrical mechanical systems device, nanoelectrical mechanical systems device, microchemical systems, microprocessor, semiconductor, crystalline lattice, microfluidics or nanofluidics channel, or a plurality, multiplicity, series or combination of any such forms or structures or any such or similar forms or structures.
a means to excite at least one form of electromagnetic excitation or light-matter interactions in a structure, which incorporates at least one material which contains at least an addressable frequency in at least a flexible, conformable, addressable structure at least portions of which may be instructed to cause the transfer of precise localized thermal energy, expressed in at least a matrix, film, lattice, mesh, membrane, screen, mask, micro electrical mechanical systems device, nanoelectrical mechanical systems device, microchemical systems, microprocessor, semiconductor, crystalline lattice, microfluidics or nanofluidics channel, or a plurality, multiplicity, series or combination of any such forms or structures or any such or similar forms or structures.
a means to excite at least one form of electromagnetic energy to cause at least the combination of at least a combination of gasses.
a means to excite at least one form of electromagnetic energy to cause at least the combination of at least a material in the form of a gas, solid, plasma or liquid.
a means to excite at least one form of electromagnetic energy to cause at least the combination of at least a combination of materials in the form of a gas, solid, plasma or liquid.
a means to excite at least one form of electromagnetic energy to cause at least the separation of at least a gas.
a means to excite at least one form of electromagnetic energy to cause at least the separation of at least a combination of gasses.
a means to excite at least one form of electromagnetic energy to cause at least the separation of at least a material in the form of a gas, solid, plasma or liquid.
a means to excite at least one form of electromagnetic energy to cause at least the separation of at least a combination of materials in the form of a gas, solid, plasma or liquid.
a means to excite at least one form of electromagnetic energy to cause at least the reformation of at least a gas.
a means to excite at least one form of electromagnetic energy to cause at least the reformation of at least a combination of gasses.
a means to excite at least one form of electromagnetic energy to cause at least the reformation of at least a material in the form of a gas, solid, plasma or liquid.
a means to excite at least one form of electromagnetic energy to cause at least the reformation of at least a combination of materials in the form of a gas, solid, plasma or liquid.
a means to excite at least one form of electromagnetic energy to cause at least the reclamation of at least a gas.
a means to excite at least one form of electromagnetic energy to cause at least the reclamation of at least a combination of gasses.
a means to excite at least one form of electromagnetic energy to cause at least the reclamation of at least a material in the form of a gas, solid, plasma or liquid.
a means to excite at least one form of electromagnetic energy to cause at least the reclamation of at least a combination of materials in the form of a gas, solid, plasma or liquid.

4. The method of claim 1 to use resonant light-matter interaction to initiate and control the selective excitation of or any of electrons, molecules, particles, materials or structures including:
a means to use electromagnetic radiation or energy transfer for the selective excitation of or any of electrons, molecules, particles, materials or structures.
a means to use surface plasmon resonant frequency effects for the selective excitation of or any of electrons, molecules, particles, materials or structures

5. The method of claim 1 which includes a means to control the plasmon resonant frequency or at least the electromagnetic excitation of at least the resonant frequency of a selected structure or material including:
a means to control exciting the plasmon resonant frequency of a selected structure or material.
a means to control at least the electromagnetic excitation of at least the resonant frequency of at least a structure or material.
a means to control at least the electromagnetic excitation of at least the resonant frequency of a combination of at least two materials.
a means to determine at least the range of at least a resonant frequency for at least the electromagnetic excitation of at least the resonant frequency of at least a material.
a means to determine at least the absorption of at least a unit of electromagnetic energy by at least a material or combination of materials including at least a metallic, nonmetallic, organic, inorganic, metal organic, silicon, silica, silicate, ceramic, composite or polymer.
a means to determine at least the absorption of at least a unit of electromagnetic energy by at least a material or combination of materials in the form of a gas, solid, plasma or liquid.
a means to determine at least the refraction of at least a unit of electromagnetic energy by at least a material or combination of materials including at least a metallic, nonmetallic, organic, inorganic, metal organic, silicon, silica, silicate, ceramic, composite or polymer.
a means to determine at least the refraction of at least a unit of electromagnetic energy by at least a material or combination of materials in the form of a gas, solid, plasma or liquid.
a means to determine at least the scattering of at least a unit of electromagnetic energy by at least a material or combination of materials in the form of a gas, solid, plasma or liquid.
a means to determine at least the scattering of at least a unit of electromagnetic energy by at least a material or combination of materials including at least a metallic, nonmetallic, organic, inorganic, metal organic, silicon, silica, silicate, ceramic, composite or polymer.
a means to identify at least the resonant frequency of at least a material.
a means to identify at least the resonant frequency of a combination of at least two materials.
a means to sequence at least the electromagnetic excitation of at least the resonant frequency of at least a material.
a means to sequence at least the electromagnetic excitation of at least the resonant frequency of at least a combination of at least two materials.
a means to organize at least the electromagnetic excitation of at least the resonant frequency of at least a structure.
a means to organize at least the electromagnetic excitation of at least the resonant frequency of at least a combination of at least two structures.
a means to program at least the electromagnetic excitation of at least the resonant frequency of at least a structure.
a means to program at least the electromagnetic excitation of at least the resonant frequency of at least a combination of at least two structures.
a means to cycle at least the electromagnetic excitation of at least the resonant frequency of at least a structure.
a means to cycle at least the electromagnetic excitation of at least the resonant frequency of at least a combination of at least two structures.
a means to repeat at least the electromagnetic excitation of at least the resonant frequency of at least a structure.
a means to repeat at least the electromagnetic excitation of at least the resonant frequency of at least a combination of at least two structures.
a means to automate at least the electromagnetic excitation of at least the resonant frequency of at least a structure.
a means to automate at least the electromagnetic excitation of at least the resonant frequency of at least a combination of at least two structures.

6. A method to initiate or control at least one form of electromagnetic excitation or light matter interaction for catalysis or photocatalysis including:
a means to initiate and control catalytic chemical reactions caused by light-matter interactions in metallic nanoparticles.
a means to initiate and control the use of light-matter interactions to cause a catalytic chemical reaction without heating the entire reaction chamber.
a means to initiate and control the use of light-matter interactions to cause a catalytic chemical reaction without heating the entire reactor mass.
a means to initiate and control the use of light-matter interactions to cause a catalytic chemical reaction without heating the entire reactant.
a means to initiate and control the use of light-matter interactions to cause a catalytic chemical reaction without heating the entire product.
a means to initiate and control the use of light-matter interactions to cause a catalytic chemical reaction without heating the entire reactor substrate.
a means to initiate and control the use of electromagnetic excitation to cause a catalytic chemical reaction without heating the entire reaction chamber.
a means to initiate and control the use of electromagnetic excitation to cause a catalytic chemical reaction without heating the entire reactor mass.
a means to initiate and control the use of electromagnetic excitation to cause a catalytic chemical reaction without heating the entire reactant.
a means to initiate and control the use of electromagnetic excitation to cause a catalytic chemical reaction without heating the entire reaction product.
a means to initiate and control the use of electromagnetic excitation to cause a catalytic chemical reaction without heating the entire reactor substrate.
a means to use plasmon enhanced light-matter interactions in metallic particles to extend the effects of catalytic chemical reactions to adjacent particles, materials or structures, whether metallic or non-metallic.
a means to use plasmon enhanced light-matter interactions in metallic particles to initiate and control catalytic chemical reactions in adjacent particles, materials or structures, whether metallic or non-metallic.
a means to use plasmon enhanced light-matter interactions in metallic particles to extend the effects of catalytic chemical reactions to adjacent particles, materials or structures, whether organic or inorganic.
a means to use plasmon enhanced light-matter interactions in metallic particles to initiate and control catalytic chemical reactions in adjacent particles, materials or structures, whether organic or inorganic.
a means to perform gas analysis on the reactants and the products in-situ during growth or catalysis.

7. The method of claim 6 to initiate and control the resonant frequency associated with light-matter interactions in a material or structure by changing any one of or any number of the morphology, geometry, density, integrity, consistency, or transparency properties of the material including:
a means to initiate and control the resonance frequency of a structure by changing any one of or any number of the morphology, geometry, density, integrity, consistency, or transparency properties of the material.
a means to initiate and control the resonance frequency of a structure by changing the refractive index of the host medium or substrate
a means to initiate and control the resonance frequency of a structure by changing the dielectric environment, e.g. by placing other metallic particles adjacent or in proximity to the catalyst site.
a means to initiate and control the resonant frequency associated with light-matter interactions of a material or structure by changing the substrate index of the material.
a means to initiate and control the resonant frequency associated with light-matter interactions of a material or structure by changing the polarization of the light beam incident on the material.
a means to initiate and control the light-matter resonant frequency of a selected structure.
a means to initiate and control the light-matter resonant frequency of a selected material.

8. A method to initiate or control at least one form of electromagnetic excitation or light matter interaction to cause reactions or chemical reactions including:
a means to initiate and control chemical reactions caused by light-matter interactions in metallic nanoparticles.
a means to initiate and control chemical vapor deposition using light-matter interactions in metallic nanoparticles.
a means to initiate and control chemical reactions caused by electromagnetic excitation.
a means to initiate and control the processing of materials or structures using chemical reactions caused by electromagnetic excitation.
a means to initiate and control the use of light-matter interactions to cause a chemical reaction without heating the entire reaction chamber.
a means to initiate and control the use of light-matter interactions to cause a chemical reaction without heating the entire reactor mass.
a means to initiate and control the use of light-matter interactions to cause a chemical reaction without heating the entire reactant.
a means to initiate and control the use of light-matter interactions to cause a chemical reaction without heating the entire reaction product.
a means to initiate and control the use of light-matter interactions to cause a chemical reaction without heating the entire reactor substrate.
a means to initiate and control the use of electromagnetic excitation to cause a chemical reaction without heating the entire reaction chamber.
a means to initiate and control the use of electromagnetic excitation to cause a chemical reaction without heating the entire reactor mass.
a means to initiate and control the use of electromagnetic excitation to cause a chemical reaction without heating the entire reactant.
a means to initiate and control the use of electromagnetic excitation to cause a chemical reaction without heating the entire reaction product.
a means to initiate and control the use of electromagnetic excitation to cause a chemical reaction without heating the entire reactor substrate.
a means to initiate and control chemical reactions caused by plasmon assisted heating.
a means to initiate and control chemical reactions caused by plasmon assisted reactions.
a means to initiate and control chemical reactions caused by electromagnetic excitation.
a means to initiate and control the processing of materials using chemical reactions caused by electromagnetic excitation.
a means to use plasmon enhanced light-matter interactions in metallic particles to extend the effects of chemical reactions to adjacent particles, materials or structures, whether metallic or non-metallic.
a means to use plasmon enhanced light-matter interactions in metallic particles to initiate and control chemical reactions in adjacent particles, materials or structures, whether metallic or non-metallic.
a means to use plasmon enhanced light-matter interactions in metallic particles to extend the effects of chemical reactions to adjacent particles, materials or structures, whether organic or inorganic.
a means to use plasmon enhanced light-matter interactions in metallic particles to initiate and control chemical reactions in adjacent particles, materials or structures, whether organic or inorganic.
a means to control chemical vapor deposition using plasmon assisted reactions.
a means to control plasmon assisted reactions spatially and temporally.
a means to perform gas analysis on the reactants and the products in-situ during growth or a chemical reaction,
a means to use plasmon enhanced light-matter interactions in metallic particles to control chemical reactions in adjacent particles, materials or structures, whether metallic or non-metallic.
